(19) United States
(12) Patent Application Publication
(10) Pub. No.: US 2018/0269014 A1
(43) Pub. Date: Sep. 20, 2018

(54) KEYBOARD DEVICE AND METHOD FOR MANUFACTURING KEY FRAME THEREOF

(71) Applicant: Primax Electronics Ltd., Taipei (TW)

(72) Inventors: Tsu-Yi CHEN, Taipei (TW); Yi-Te CHOU, Taipei (TW); Yu-Ming LIN, Taipei (TW)

(21) Appl. No.: 15/684,161

(22) Filed: Aug. 23, 2017

(30) Foreign Application Priority Data
Mar. 17, 2017 (TW) 106108935

(51) Int. Cl. H01H 13/85; H01H 13/704; G06F 3/02; B41M 5/26

(52) U.S. Cl. CPC H01H 13/85; H01H 13/704; H01H 2229/044; B41M 5/267; G06F 3/0202

(57) ABSTRACT

A keyboard device includes a key frame. The key frame includes a main body and a receiving hole. The receiving hole runs through the main body along a vertical direction. A keycap is movable within the receiving hole. The main body includes a first substrate layer, a second substrate layer and a contact layer. The first substrate layer and the second substrate layer are staked along the vertical direction. The contact layer is arranged between the first substrate layer and the second substrate layer. The second substrate layer is combined with the first substrate layer through the contact layer. The first substrate layer is made of a first material. The second substrate layer is made of a second material. The hardness of the second material is lower than the hardness of the first material.

### FIELD OF THE INVENTION

The present invention relates to an input device, and more particularly to a keyboard device and a method for manufacturing a key frame of the keyboard device.

### BACKGROUND OF THE INVENTION

Generally, the widely-used peripheral input device of a computer system includes for example a mouse device, a keyboard device, a trackball device, or the like. Via the keyboard device, characters or symbols can be inputted into the computer system directly. As a consequence, most users and most manufacturers of the input devices pay much attention to the keyboard devices.

Hereinafter, the structure and the function of a conventional keyboard device will be illustrated with reference to FIGS. 1, 2 and 3. FIG. 1 is a schematic top view illustrating the outward appearance of a conventional keyboard device. FIG. 2 is a schematic perspective view illustrating a portion of the conventional keyboard device of FIG. 1. FIG. 3 is a schematic exploded view illustrating a portion of the conventional keyboard device of FIG. 1. For succinctness, only a portion of the key frame, a single key structure and associated components are shown in FIGS. 2 and 3.

The conventional keyboard device 1 comprises plural key structures 10, a base plate 11, a membrane circuit board 12 and a key frame 13. The membrane circuit board 12 comprises plural membrane switches 121 corresponding to the plural key structures 10. Each of the plural key structures 10 comprises a keycap 101, a scissors-type connecting element 102 and an elastic element 103. The scissors-type connecting element 102 is connected between the keycap 101 and the base plate 11. Moreover, the scissors-type connecting element 102 comprises a first frame 1021 and a second frame 1022. The second frame 1022 is pivotally coupled to the first frame 1021. Consequently, the first frame 1021 and the second frame 1022 can be swung relative to each other. The elastic element 103 is arranged between the keycap 101 and the base plate 11. Moreover, the elastic element 103 comprises a contacting part (not shown).

While the keycap 101 of any key structure 10 is depressed and moved downwardly relative to the base plate 11, the first frame 1021 and the second frame 1022 of the scissors-type connecting element 102 are switched from an open-scissors state to a stacked state. Moreover, as the keycap 101 is moved downwardly to compress the elastic element 103, the corresponding membrane switch 121 is pushed and triggered by the contacting part of the elastic element 103. Consequently, the keyboard device 1 generates a corresponding key signal. When the keycap 101 of the key structure 10 is no longer depressed, the keycap 101 is moved upwardly relative to the base plate 11 in response to an elastic force of the elastic element 103. Meanwhile, the first frame 1021 and the second frame 1022 are switched from the stacked state to the open-scissors state again, and the keycap 101 is returned to its original position.

The key frame 13 is located over the membrane circuit board 12. Moreover, the key frame 13 comprises a main body 132 and plural receiving holes 131 corresponding to the plural key structures 10. The keycap 101 of the key structure 10 is movable within the corresponding receiving hole 131. For achieving some special purposes, the keyboard device 1 is specially designed. For example, the keyboard device 1 has a special mechanism for allowing the keycaps 101 to be ascended or descended in response to the movement of the key frame 13. Consequently, the keyboard device 1 has a slim shape when a notebook computer (not shown) with the keyboard device 1 is carried by the user. Moreover, while the keyboard device 1 is operated by the user, the keycap 101 generates a larger travelling distance to provide better tactile feel to the user. This mechanism is well known to those skilled in the art, and is not redundantly described herein.

However, the above mechanism still has some drawbacks. For example, while the keyboard device 1 is operated by the user, the relative position between the keycap 101 of the key structure 10 and the key frame 13 is not friendly to the user. Please refer to FIGS. 4A and 4B. FIG. 4A schematically illustrates the relationship between the keycap of the key structure and the key frame when the keycap is not depressed. FIG. 4B schematically illustrates the relationship between the keycap of the key structure and the key frame when the keycap is depressed. For succinctness, only portions of the key structure and the key frame are shown in FIGS. 4A and 4B. After the keycap 101 of the key structure 10 of the keyboard device 1 is depressed, the keycap 101 is descended to a position lower than a top surface of the main body 132 of the key frame 13. While the keycap 101 is depressed by a user's finger 9, the main body 132 of the key frame 13 and the finger 9 are interfered by each other. Consequently, the tactile feel is deteriorated. The interfered region is indicated by a circumscribed mark as shown in FIG. 4B. In other words, the conventional keyboard device 1 needs to be further improved.

### SUMMARY OF THE INVENTION

An object of the present invention provides a keyboard device with a key frame. The key frame is made of plural materials. Consequently, the tactile feel of depressing the keycap of the keyboard device is enhanced.

Another object of the present invention provides a method for manufacturing a key frame of a keyboard device in order to simplify the process of aligning plural materials.

In accordance with an aspect of the present invention, there is provided a keyboard device. The keyboard device includes a membrane circuit board, a key frame and a key structure. The membrane circuit board includes a membrane switch. The key frame is located over the membrane circuit board. The key frame includes a main body and a receiving hole. The receiving hole runs through the main body along a vertical direction. The main body includes a first substrate layer, a second substrate layer and a contact layer. The first substrate layer and the second substrate layer are staked along the vertical direction. The contact layer is arranged between the first substrate layer and the second substrate layer. The second substrate layer is combined with the first substrate layer through the contact layer. The key structure is aligned with the membrane switch. The key structure includes a keycap. When the keycap is depressed, the keycap is moved within the receiving hole.

In accordance with another aspect of the present invention, there is provided a method for manufacturing a key frame of a keyboard device. The key frame includes a main body and plural receiving holes. Moreover, plural keycaps of the keyboard device are movable within the plural receiving holes. The method includes the following steps. Firstly, a first substrate layer of the main body is produced by an injection molding process. The first substrate layer is made of a first material. The first substrate layer includes plural first openings corresponding to the plural receiving holes. Then, a single substrate and the first substrate layer are combined together through a contact layer. The single substrate is made of a second material. Then, a cutting process is performed on the single substrate to generate plural second openings corresponding to the plural receiving holes in the single substrate, so that a second substrate layer of the main body is produced. Each of the second openings is in communication with the corresponding first opening.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional keyboard device;

FIG. 2 is a schematic perspective view illustrating a portion of the conventional keyboard device of FIG. 1;

FIG. 3 is a schematic exploded view illustrating a portion of the conventional keyboard device of FIG. 1;

FIG. 4A schematically illustrates the relationship between the keycap of the key structure and the key frame when the keycap is not depressed;

FIG. 4B schematically illustrates the relationship between the keycap of the key structure and the key frame when the keycap is depressed;

FIG. 5 is a schematic top view illustrating the outward appearance of a keyboard device according to a first embodiment of the present invention;

FIG. 6 is a schematic perspective view illustrating a portion of the keyboard device of FIG. 5;

FIG. 7 is a schematic exploded view illustrating a portion of the keyboard device of FIG. 5;

FIG. 8 is a schematic exploded view illustrating the membrane circuit board of the keyboard device of FIG. 5;

FIG. 9A schematically illustrates the relationship between the keycap and the key frame of the keyboard device of FIG. 5 when the keycap is not depressed;

FIG. 9B schematically illustrates the relationship between the keycap and the key frame of the keyboard device of FIG. 5 when the keycap is depressed;

FIG. 10 is a flowchart illustrating a method for manufacturing a key frame of a keyboard device according to an embodiment of the present invention;

FIG. 11A schematically illustrates the first step of the method of FIG. 10;

FIG. 11B schematically illustrates the second step of the method of FIG. 10;

FIG. 11C schematically illustrates the third step of the method of FIG. 10;

FIG. 12 schematically illustrates the relationship between a keycap and a key frame of a keyboard device according to a second embodiment of the present invention; and

FIG. 13 schematically illustrates the relationship between the keycap and the key frame of the keyboard device of FIG. 12, in which the keycap is depressed.

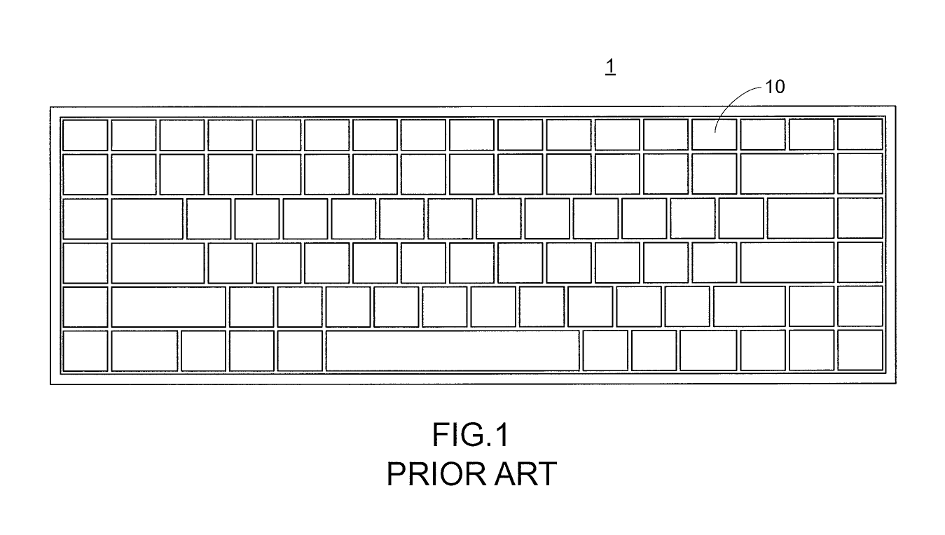

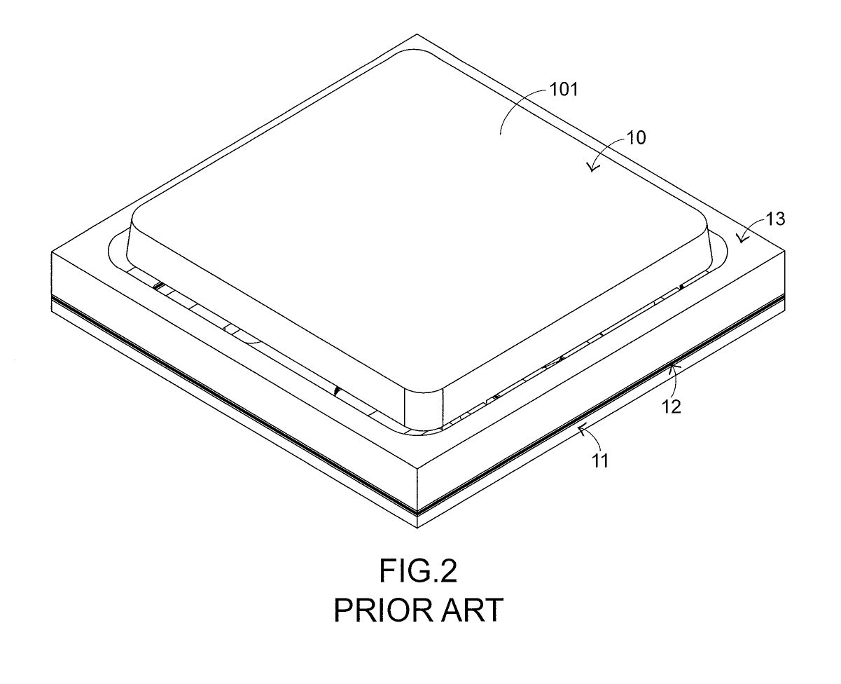

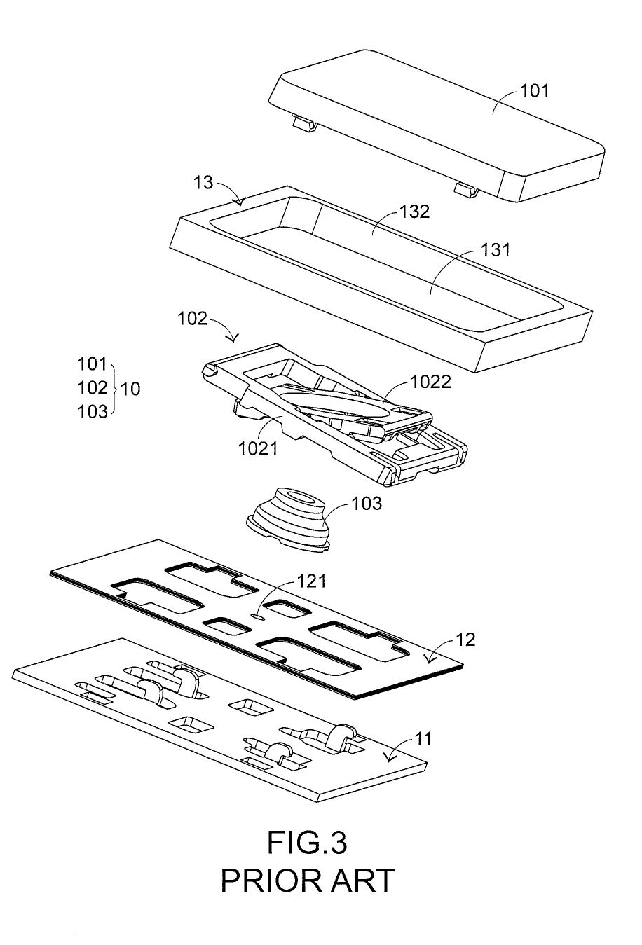

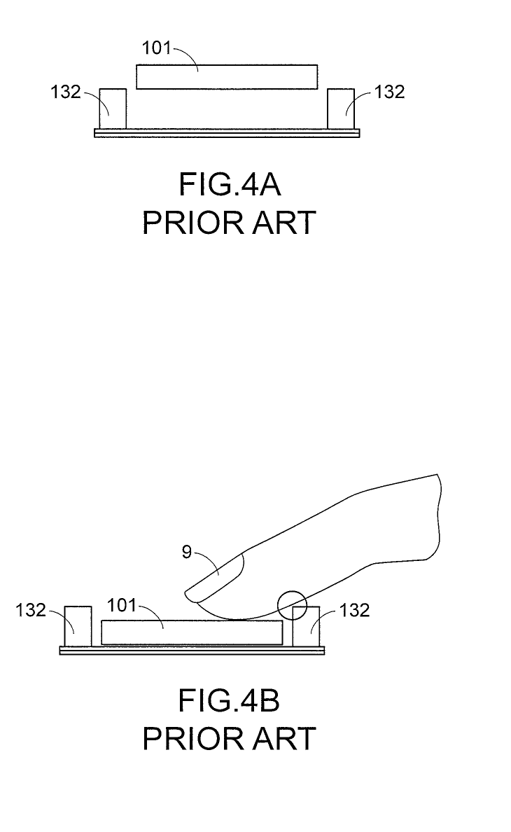

### DETAILED DESCRIPTION OF THE PREFERRED EMBODIMENT

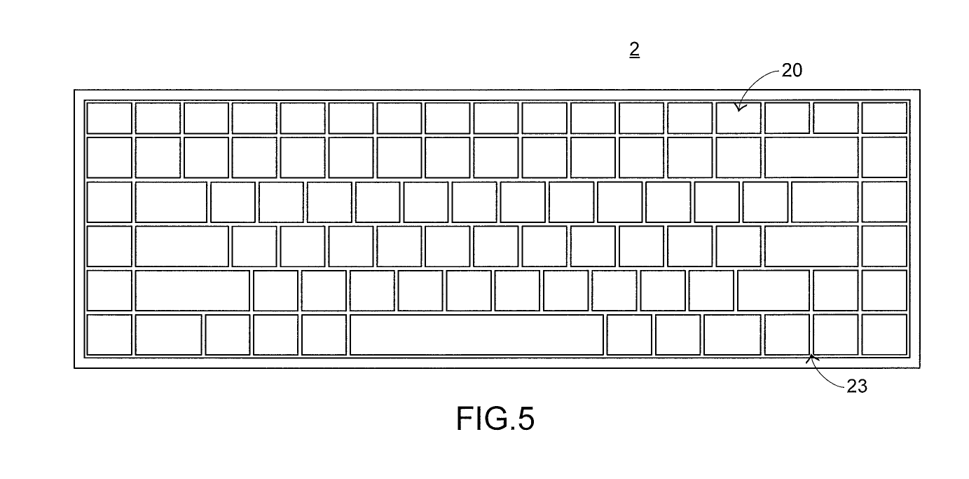

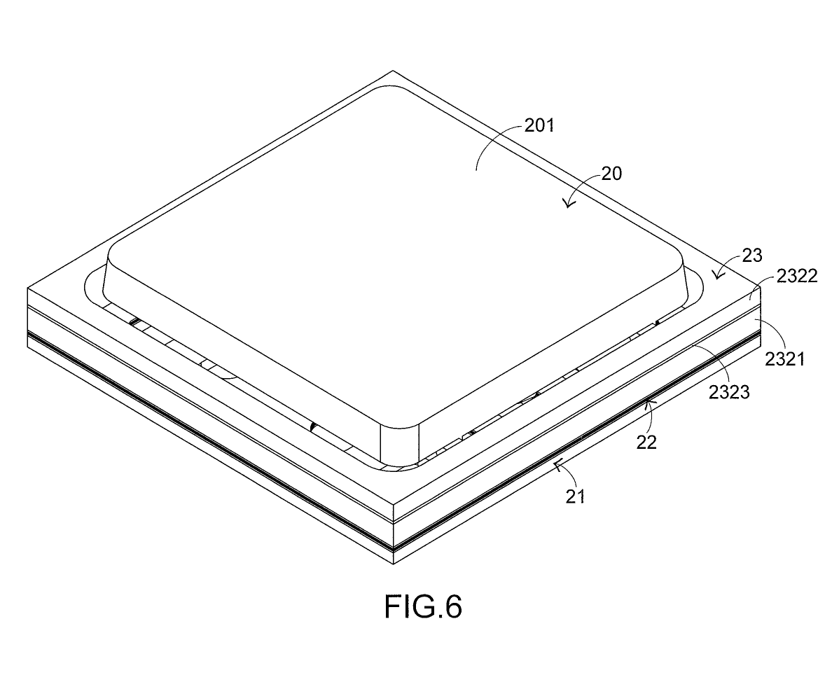

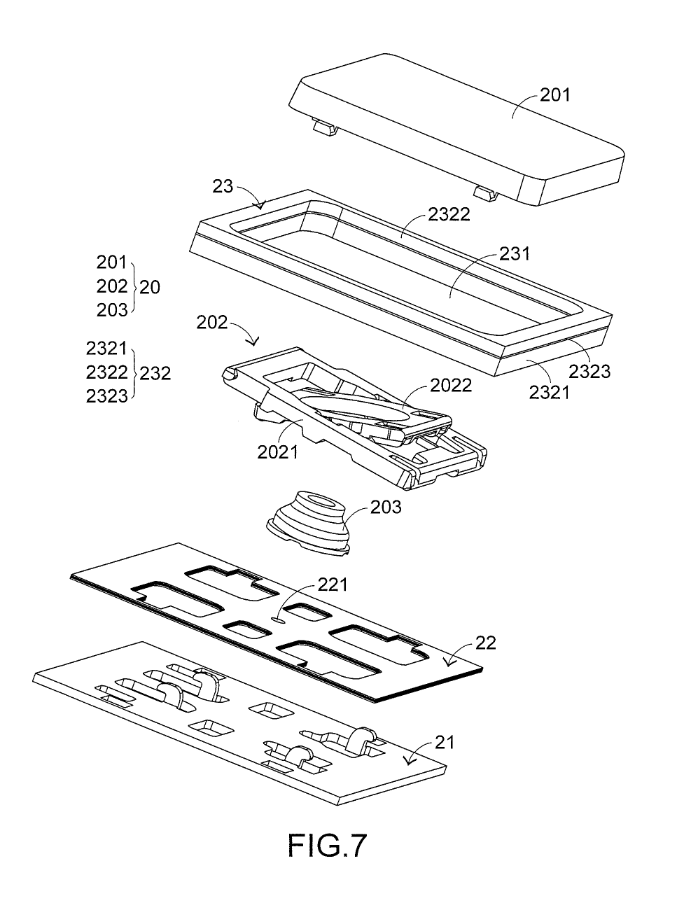

Please refer to FIGS. 5, 6 and 7. FIG. 5 is a schematic top view illustrating the outward appearance of a keyboard device according to a first embodiment of the present invention. FIG. 6 is a schematic perspective view illustrating a portion of the keyboard device of FIG. 5. FIG. 7 is a schematic exploded view illustrating a portion of the keyboard device of FIG. 5. For succinctness, only a portion of the key frame, a single key structure and associated components are shown in FIGS. 6 and 7. In this embodiment, the keyboard device 2 comprises plural key structures 20, a base plate 21, a membrane circuit board 22 and a key frame 23. These key structures 20 are classified into some types, e.g., ordinary keys, numeric keys and function keys. When one of the key structures 20 is depressed by the user's finger, a corresponding key signal is generated to the computer, and thus the computer executes a function corresponding to the depressed key. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

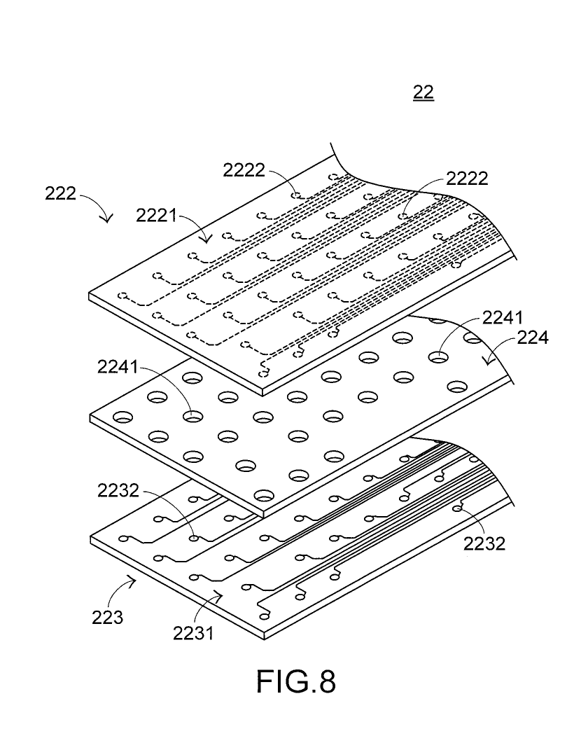

FIG. 8 is a schematic exploded view illustrating the membrane circuit board of the keyboard device of FIG. 5. The membrane circuit board 22 comprises plural film layers, which are arranged in a stack form. In this embodiment, the plural film layers of the membrane circuit board 22 comprise an upper film layer 222 and a lower film layer 223. A first circuit pattern 2221 is formed on a bottom surface of the upper film layer 222. The first circuit pattern 2221 comprises plural upper contacts 2222 corresponding to the plural key structures 20. A second circuit pattern 2231 is formed on a top surface of the lower film layer 223. The second circuit pattern 2231 comprises plural lower contacts 2232 corresponding to the plural upper contacts 2222. Each of the upper contacts 2222 and the corresponding lower contact 2232 are separated from each other by a spacing distance. Moreover, each of the upper contacts 2222 and the corresponding lower contact 2232 are collectively defined as a membrane switch 221. Moreover, for maintaining the spacing distance between each upper contact 2222 and the corresponding lower contact 2232, the membrane circuit board 22 further comprises an intermediate film layer 224. The intermediate film layer 224 is arranged between the upper film layer 222 and the lower film layer 223. In addition, the intermediate film layer 224 comprises plural perforations 2241 corresponding to the plural upper contacts 2222 and the plural lower contacts 2232. Preferably but not exclusively, at least one of the upper film layer 222, the lower film layer 223 and the intermediate film layer 224 is made of polycarbonate (PC), polyethylene terephthalate (PET), polymethylmethacrylate (PMMA), polyurethane (PU) or polyimide (PI).

Each of the plural key structures 20 comprises a keycap 201, a connecting element 202 and an elastic element 203. The connecting element 202 is connected between the keycap 201 and the base plate 21. Through the connecting element 202, the keycap 201 is moved upwardly or downwardly relative to the base plate 21. The elastic element 203 is arranged between the keycap 201 and the base plate 21. Moreover, the elastic element 203 comprises a contacting part (not shown). In this embodiment, the connecting element 202 is a scissors-type connecting element. Moreover, the connecting element 202 comprises a first frame 2021 and a second frame 2022. The second frame 2022 is pivotally coupled to the first frame 2021. Consequently, the first frame 2021 and the second frame 2022 can be swung relative to each other.

While the keycap 201 of any key structure 20 is depressed and moved downwardly relative to the base plate 21, the first frame 2021 and the second frame 2022 of the scissors-type connecting element 202 are switched from an open-scissors state to a stacked state. Moreover, as the keycap 201 is moved downwardly to compress the elastic element 203, the corresponding upper contact 2222 is pushed and triggered by the contacting part of the elastic element 203. Consequently, the corresponding upper contact 2222 is contacted with the corresponding lower contact 2232 through the corresponding perforation 2241. In such way, the corresponding membrane switch 221 is electrically conducted, and the keyboard device 2 generates a corresponding key signal. When the keycap 201 of the key structure 20 is no longer depressed, the keycap 201 is moved upwardly relative to the base plate 21 in response to an elastic force of the elastic element 203. Meanwhile, the first frame 2021 and the second frame 2022 are switched from the stacked state to the open-scissors state again, and the keycap 201 is returned to its original position. The connecting relationships between the connecting element 202, the base plate 21 and the keycap 201 are presented herein for purpose of illustration and description only.

The key frame 23 is located over the membrane circuit board 22. Moreover, the key frame 23 comprises a main body 232 and plural receiving holes 231 corresponding to the plural key structures 20. The plural receiving holes 231 run through the main body 232 along a vertical direction. The keycap 201 of the key structure 20 is movable within the corresponding receiving hole 231. For achieving some special purposes, the keyboard device 2 is specially designed. For example, the keyboard device 2 has a special mechanism for allowing the keycaps 201 to be ascended or descended in response to the movement of the key frame 23. Consequently, the keyboard device 2 has a slim shape when a notebook computer (not shown) with the keyboard device 2 is carried by the user. Moreover, while the keyboard device 2 is operated by the user, the keycap 201 generates a larger travelling distance to provide batter tactile feel to the user. This mechanism is well known to those skilled in the art, and is not redundantly described herein.

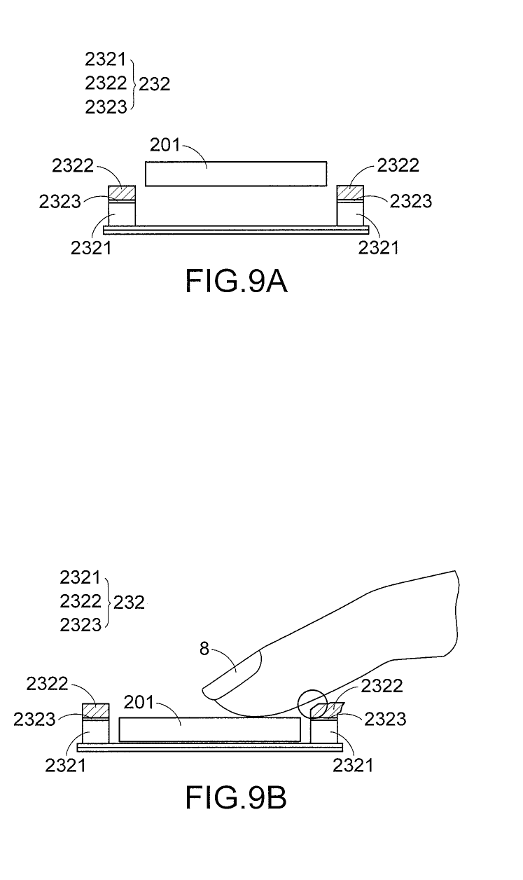

In this embodiment, the main body 232 of the key frame 23 comprises a first substrate layer 2321, a second substrate layer 2322 and a contact layer 2323. The first substrate layer 2321 and the second substrate layer 2322 are staked along the vertical direction. The contact layer 2323 is arranged between the first substrate layer 2321 and the second substrate layer 2322. The second substrate layer 2322 is combined with the first substrate layer 2321 through the contact layer 2323. The first substrate layer 2321 is made of a first material. The second substrate layer 2322 is made of a second material. The hardness of the second material is lower than the hardness of the first material. The benefits of this design will be described with reference to FIGS. 9A and 9B.

Please refer to FIGS. 9A and 9B. FIG. 9A schematically illustrates the relationship between the keycap and the key frame of the keyboard device of FIG. 5 when the keycap is not depressed. FIG. 9B schematically illustrates the relationship between the keycap and the key frame of the keyboard device of FIG. 5 when the keycap is depressed. For succinctness, only portions of the key structure and the key frame are shown in FIGS. 9A and 9B. After the keycap 201 of the key structure 20 of the keyboard device 2 is depressed, the top surface of keycap 201 is at a level lower than a top surface of the second substrate layer 2322 of the key frame 23. Similarly, while the keycap 201 is depressed by a user's finger 8, the second substrate layer 2322 and the user's finger 8 are interfered by each other. Since the second substrate layer 2322 is made of a soft material, the deformation extent of the second substrate layer 2322 varies with the applied pressure. Under this circumstance, the influence of the sharp-pointed corners on the operation of the user's finger is largely reduced. The interfered region is indicated by a circumscribed mark as shown in FIG. 9B.

Preferably but not exclusively, the first material is a plastic material, a metallic material or any other comparable material with higher hardness. For example, the first material is acrylonitile-butadiene-styrene copolymer (ABS) or aluminum, which is conventionally used to fabricate the key frame. Preferably but not exclusively, the second material is leather or foam. If the second material is leather, the interference between the user's finger 8 and the key frame is reduced while the keycap 201 is depressed. Moreover, if the second material is leather, the second substrate layer 2322 may have a color pattern such as a decorative pattern. In comparison with the conventional key frame with the monochromatic texture, the key frame of the present invention is aesthetically-pleasing. Moreover, the second substrate layer 2322 made of leather can facilitate the user to identify the keycap 201.

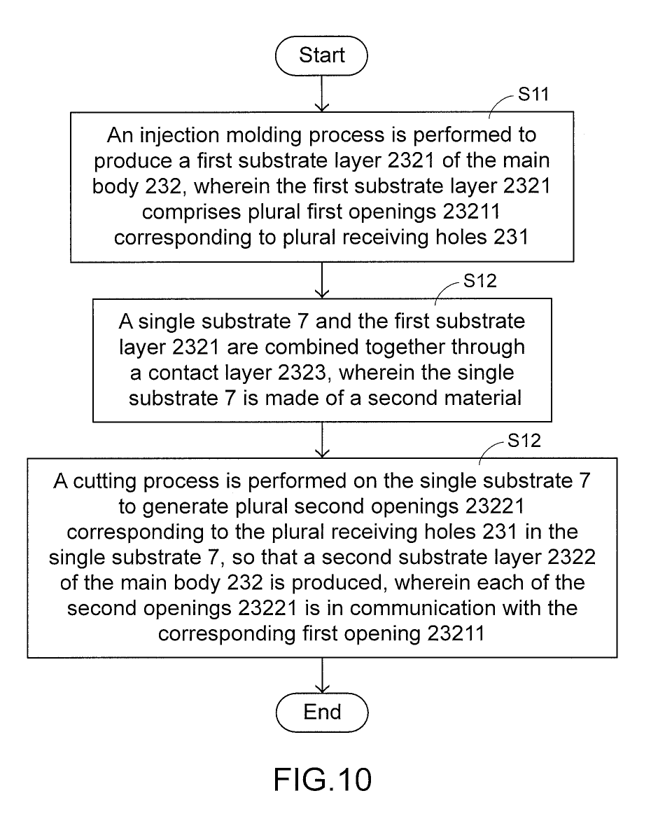

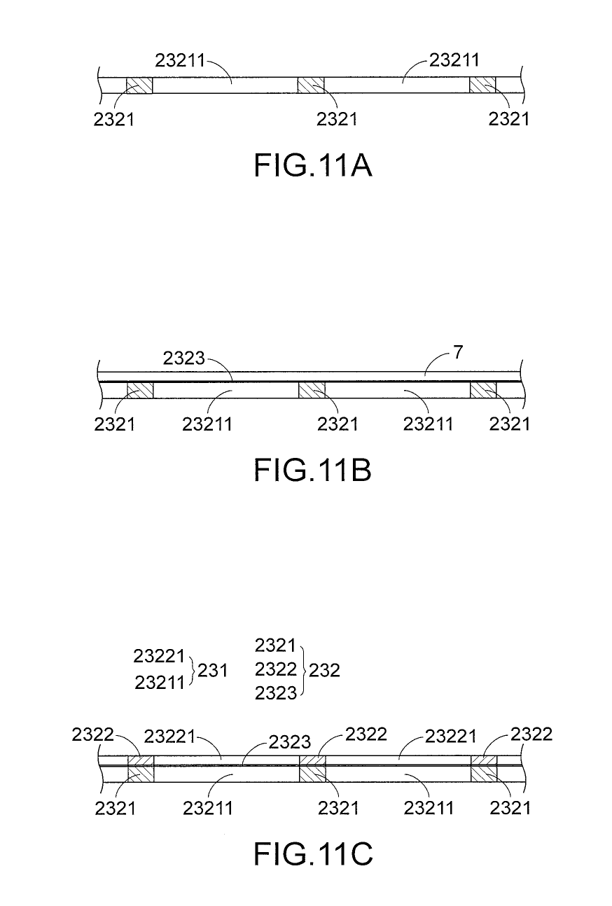

A method for manufacturing a key frame of a keyboard device will be described as follows. FIG. 10 is a flowchart illustrating a method for manufacturing a key frame of a keyboard device according to an embodiment of the present invention. Firstly, an injection molding process is performed to produce a first substrate layer 2321 of the main body 232 (Step S11). As shown in FIG. 11A, the first substrate layer 2321 comprises plural first openings 23211 corresponding to plural receiving holes 231. Then, as shown in FIG. 11B, a single substrate 7 made of a second material and the first substrate layer 2321 are combined together through a contact layer 2323 (Step S12). Then, in a step S13, a cutting process is performed on the single substrate 7 to generate plural second openings 23221 corresponding to the plural receiving holes 231 in the single substrate 7. Consequently, a second substrate layer 2322 of the main body 232 is produced. Each of the second openings 23221 is in communication with the corresponding first opening 23211. That is, each second opening 23221 and the corresponding first opening 23211 are collaboratively formed as the corresponding receiving hole 231. The resulting structure is shown in FIG. 11C.

Preferably but not exclusively, the cutting process is a beam cutting process that uses a high energy light beam (e.g., a laser beam) to cut the single substrate 7. In accordance with the present invention, the single substrate 7 and the first substrate layer 231 are firstly combined together, and then the second openings 23221 are formed in the single substrate 7 by the cutting process. In such way, the process of aligning the plural second openings 23221 of the second substrate layer 2322 with the plural first openings 23211 of the first substrate layer 2321 will be simplified.

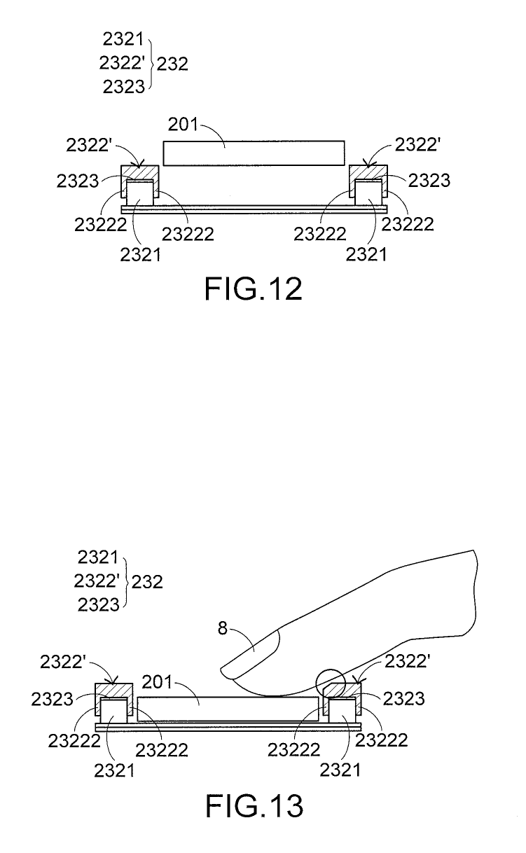

FIG. 12 schematically illustrates the relationship between a keycap and a key frame of a keyboard device according to a second embodiment of the present invention. For succinctness, only portions of the key structure and the key frame are shown in FIG. 12. The structure and function of the keyboard device that are similar to those of the first embodiment are not redundantly described herein. In comparison with the first embodiment, the second substrate layer 2322′ of the key frame of this embodiment comprises a skirt part 23222 that is protruded downwardly. The second substrate layer 2322′ is moved downwardly and sheathed around the first substrate layer 2321 through the skirt part 23222. After the second substrate layer 2322′ is sheathed around the first substrate layer 2321, the second substrate layer 2322′ is still fixed on the first substrate layer 2321 through the contact layer 2323.

FIG. 13 schematically illustrates the relationship between the keycap and the key frame of the keyboard device of FIG. 12, in which the keycap is depressed. While the keycap 201 is depressed, the top surface of the keycap 201 is at a level lower than the top surface of the second substrate layer 2322′. Similarly, while the keycap 201 is depressed by a user's finger 8, the second substrate layer 2322′ and the user's finger 8 are interfered by each other. Since the second substrate layer 2322′ is made of a soft material, the deformation extent of the second substrate layer 2322′ varies with the applied pressure. Under this circumstance, the influence of the sharp-pointed corners on the operation of the user's finger 8 is largely reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a membrane circuit board comprising a membrane switch;
a key frame located over the membrane circuit board, and comprising a main body and a receiving hole, wherein the receiving hole runs through the main body along a vertical direction, and the main body comprises a first substrate layer, a second substrate layer and a contact layer, wherein the first substrate layer and the second substrate layer are staked along the vertical direction, the contact layer is arranged between the first substrate layer and the second substrate layer, and the second substrate layer is combined with the first substrate layer through the contact layer; and
a key structure aligned with the membrane switch, and comprising a keycap, wherein when the keycap is depressed, the keycap is moved within the receiving hole.

2. The keyboard device according to claim 1, wherein after the keycap is depressed and the membrane switch is triggered by the key structure, a top surface of the keycap is at a level lower than a top surface of the second substrate layer.

3. The keyboard device according to claim 1, wherein the keycap is ascended or descended in response to a movement of the key frame.

4. The keyboard device according to claim 1, wherein the first substrate layer is made of a first material, and the second substrate layer is made of a second material, wherein a hardness of the second material is lower than a hardness of the first material.

5. The keyboard device according to claim 4, wherein the second material is leather or foam.

6. The keyboard device according to claim 4, wherein the first material is plastic material or metallic material.

7. The keyboard device according to claim 1, wherein the second substrate layer comprises at least one color pattern.

8. The keyboard device according to claim 1, wherein the second substrate layer comprises a skirt part that is protruded downwardly, and the second substrate layer is sheathed around the first substrate layer through the skirt part.

9. The keyboard device according to claim 1, wherein the membrane circuit board comprises an upper film layer and a lower film layer, wherein a first circuit pattern is formed on the upper film layer, a second circuit pattern is formed on the lower film layer, the first circuit pattern comprises an upper contact, and the second circuit pattern comprises a lower contact, wherein the upper contact and the lower contact are separated from each by a spacing distance and collectively defined as the membrane switch.

10. The keyboard device according to claim 1, wherein the keyboard device further comprises a base plate, and the key structure further comprises a connecting element, wherein the connecting element is connected between the base plate and the corresponding keycap, and the keycap is movable upwardly or downwardly relative to the base plate through the connecting element.

11. The keyboard device according to claim 10, wherein the connecting element is a scissors-type connecting element comprising a first frame and a second frame, and the second frame is pivotally coupled to the first frame.

12. A method for manufacturing a key frame of a keyboard device, the key frame comprising a main body and plural receiving holes, plural keycaps of the keyboard device being movable within the plural receiving holes, the method comprising steps of:
producing a first substrate layer of the main body by an injection molding process, wherein the first substrate layer is made of a first material, and the first substrate layer comprises plural first openings corresponding to the plural receiving holes;
combining a single substrate and the first substrate layer together through a contact layer, wherein the single substrate is made of a second material; and
performing a cutting process on the single substrate to generate plural second openings corresponding to the plural receiving holes in the single substrate, so that a second substrate layer of the main body is produced, wherein each of the second openings is in communication with the corresponding first opening.

13. The method according to claim 12, wherein the cutting process is a beam cutting process.

14. The method according to claim 12, wherein a hardness of the first material is higher than a hardness of the second material.

15. The method according to claim 14, wherein the second material is leather or foam.

16. The method according to claim 14, wherein the first material is plastic material.

17. The method according to claim 12, wherein the second substrate layer comprises at least one color pattern.

18. The method according to claim 12, wherein at least one keycap of the plural keycaps is ascended or descended in response to a movement of the key frame.
